(19) United States
(12) Patent Application Publication
(10) Pub. No.: US 2012/0084476 A1
(43) Pub. Date: Apr. 5, 2012

(54) ADVANCED TELECOMMUNICATIONS COMPUTING ARCHITECTURE EXCHANGE SYSTEM, ADVANCED TELECOMMUNICATIONS COMPUTING ARCHITECTURE EXCHANGE METHOD, AND COMMUNICATION APPARATUS

(75) Inventor: Shanfu Li, Shenzhen (CN)

(73) Assignee: Huawei Technologies Co., Ltd., Shenzhen (CN)

(21) Appl. No.: 13/315,076

(22) Filed: Dec. 8, 2011

Related U.S. Application Data
(63) Continuation of application No. PCT/CN2010/072387, filed on Apr. 30, 2010.

(30) Foreign Application Priority Data
Jun. 11, 2009 (CN) 200910107973.4

(51) Int. Cl. G06F 13/00

(52) U.S. Cl. 710/110

(57) ABSTRACT

An ATCA exchange system is disclosed according to the embodiments of the present invention. The ATCA exchange system includes: a master exchange shelf, including a first node board and a hub board; and a slave exchange shelf, including a second node board and an I/O transfer board. The I/O transfer board includes an exchange interface, and in the slave exchange shelf, the I/O transfer board is connected to the second node board through the exchange interface. The I/O transfer board is connected to the hub board by using an external communication link through the exchange interface, so that data of the second node board reaches the hub board through the I/O transfer board when the data needs to be exchanged, so as to complete data exchange through the hub board. According to the embodiments of the present invention, the manufacturing cost can be reduced.

### CROSS-REFERENCE TO RELATED APPLICATIONS

This application is a continuation of International Application No. PCT/CN2010/072387, filed on Apr. 30, 2010, which claims priority to Chinese Patent Application No. 200910107973.4, filed on Jun. 11, 2009, both of which are hereby incorporated by reference in their entireties.

### TECHNICAL FIELD

The present invention relates to the field of communications technologies, and in particular, to an Advanced Telecommunications Computing Architecture (ATCA) exchange system, an ATCA exchange method, and a communication apparatus.

### BACKGROUND

An Advanced Telecommunications Computing Architecture (ATCA) is an open industry standard architecture formulated and developed by the Peripheral Component Interconnect (PCI) Industrial Computer Manufacturers Group (PICMG), and has been widely supported by equipment suppliers and operators, and will become a mainstream platform for a future communication apparatus of high-performance, high-reliability and high-availability.

The PICMG 3.0 standard defines specifications of the structure of the ATCA and specifications of backplane interconnection topology, and the specifications specify that an ATCA system includes a shelf, a backplane, a front plugboard, and a back plugboard. The front plugboard includes hub boards and node boards, and data exchange may be performed between the node boards by adopting full mesh interconnection or through interconnection of the hub boards.

In the prior art, a dual-star exchange architecture is generally adopted, that is, two hub boards are disposed in the shelf of the ATCA, and the node boards are interconnected through the hub boards. In actual application, multiple shelves are usually disposed in a telecommunication cabinet, and two hub boards are disposed in each shelf. FIG. 1 is a schematic diagram of one-cabinet-and-two-shelves exchange, where a shelf 1 and a shelf 2 adopt the dual-star exchange architecture, and in each shelf, each node board is connected to the hub board in the shelf through a backplane. Meanwhile, hub boards in different shelves are interconnected through an I/O interface, so that the node boards in different shelves can also perform data exchange through the hub boards.

In the implementation of the present invention, the inventor finds that the prior art at least has the following disadvantages.

As a hub board needs to be disposed in each ATCA shelf in the one-cabinet-and-multiple-shelves exchange architecture (if the dual-star exchange architecture is adopted, two hub boards are needed), and the hub board includes an exchange unit and a Central Processing Unit (CPU), the cost is high; when the exchange bandwidth demand is not huge, the processing capacity of the hub board is not required to be very high, and therefore, resource waste is caused, and the manufacturing cost is increased, if the hub board is configured in this case.

### SUMMARY

Embodiments of the present invention provide an ATCA exchange system and a communication apparatus, so as to reduce the manufacturing cost.

An embodiment of the present invention provides an ATCA exchange system, where the system includes:

a master exchange shelf, including a first node board and a hub board;

a slave exchange shelf, including a second node board and an I/O transfer board, where

the I/O transfer board includes an exchange interface, and in the slave exchange shelf, the I/O transfer board is connected to the second node board through the exchange interface; and

the I/O transfer board is connected to the hub board by using an external communication link through the exchange interface, so that data of the second node board reaches the hub board through the I/O transfer board when the data needs to be exchanged, so as to complete data exchange through the hub board.

An embodiment of the present invention provides an ATCA exchange method, applicable in an ATCA exchange system, where the ATCA exchange system includes:

a master exchange shelf, including a hub board;

a slave exchange shelf, including a second node board and an I/O transfer board;

and the method includes:

receiving data of the second node board;

outputting the data to the hub board through the I/O transfer board; and

completing data exchange through the hub board.

Furthermore, an embodiment of the present invention provides a communication apparatus, where the communication apparatus includes an ATCA exchange system.

The technical solutions have the following advantages.

The I/O transfer board is disposed in the slave exchange shelf, and is adopted to transfer the data to the hub board of the master exchange shelf, so as to complete data exchange through the hub board of the master exchange shelf; therefore, a hub board is not required to be disposed in each shelf, so as to reduce the manufacturing cost.

### BRIEF DESCRIPTION OF THE DRAWINGS

To illustrate the technical solutions according to the embodiments of the present invention or in the prior art more clearly, the accompanying drawings required for describing the embodiments or the prior art are introduced below briefly. Apparently, the accompanying drawings described below merely show some of the embodiments of the present invention, and persons of ordinary skill in the art can obtain other drawings on the basis of the accompanying drawings without creative efforts.

FIG. 1 is a schematic diagram of an exchange architecture in the prior art;

FIG. 2A is a schematic diagram of an exchange architecture system according to an embodiment of the present invention;

FIG. 2B is a schematic structural diagram of an I/O transfer board according to an embodiment of the present invention;

FIG. 2C is a schematic structural diagram of another I/O transfer board according to an embodiment of the present invention; and

FIG. 2D is a schematic structural diagram of another I/O transfer board according to an embodiment of the present invention.

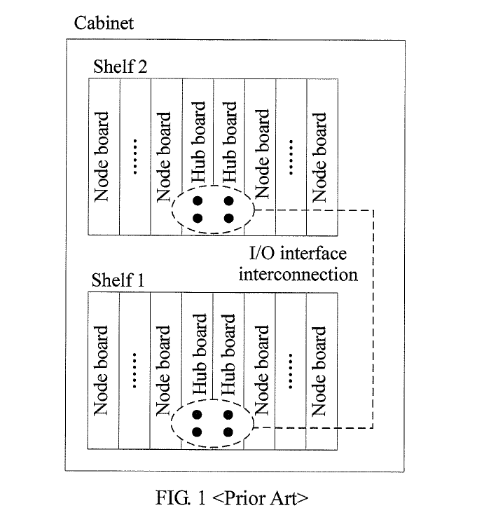

### DETAILED DESCRIPTION

The technical solutions of the embodiments of the present invention will be clearly and completely described in the following with reference to the accompanying drawings. It is obvious that the embodiments to be described are only a part rather than all of the embodiments of the present invention. All other embodiments obtained by persons skilled in the art based on the embodiments of the present invention without creative efforts shall fall within the protection scope of the present invention.

### Embodiment 1

System Embodiment 1 of the present invention provides an ATCA exchange architecture system, where the system includes:

a master exchange shelf, including a first node board and a hub board; and

a slave exchange shelf, including a second node board and an I/O transfer board.

The I/O transfer board includes an exchange interface, and in the slave exchange shelf, the I/O transfer board is connected to the second node board through the exchange interface.

The I/O transfer board is connected to the hub board by using an external communication link through the exchange interface, so that data of the second node board reaches the hub board through the I/O transfer board when the data needs to be exchanged, so as to complete data exchange through the hub board.

The external communication link includes a cable and/or an optical fiber.

The exchange interface is a RJ-45 interface and/or a Small Form-Factor Pluggable (SFP) interface.

The exchange interface is located at a panel of a front plugboard and/or a panel of a back plugboard of the I/O transfer board.

A panel of a front plugboard and/or a panel of a back plugboard of the hub board may include a second exchange interface corresponding to the exchange interface.

The I/O transfer board is disposed in the slave exchange shelf, and the I/O transfer board is adopted to transfer the data to the hub board of the master exchange shelf, so as to complete data exchange through the hub board of the master exchange shelf; therefore, a hub board is not required to be disposed in each shelf, so as to reduce the manufacturing cost.

### Embodiment 2

System Embodiment 2 of the present invention provides an ATCA exchange architecture system, where the system includes:

a master exchange shelf, disposed with a hub board and a node board; and

a slave exchange shelf, disposed with an I/O transfer board and a node board.

The I/O transfer board of the slave exchange shelf is connected to the hub board of the master exchange shelf through an external communication link.

In an application scenario of one-cabinet-and-multiple-shelves ATCA, two or more shelves are installed in one cabinet, and if the shelves need to communicate with each other, some connection relations must be established to connect the shelves. In actual application, at least one shelf may be set as a master exchange shelf, and the rest shelves are set as slave exchange shelves. In the embodiment of the present invention, one shelf is set as a master exchange shelf, and the rest shelves are set as slave exchange shelves.

In the master exchange shelf, a hub board and a node board are disposed. The number of hub boards may be one or more, and in actual application, two hub boards are generally adopted, and the two hub boards are connected to the node board through a dual-star exchange architecture, that is, each hub board is connected to all the other node boards in the shelf. The two hub boards may work in a redundancy backup manner, that is, usually an active hub board is used, and when the active hub board fails, a spare hub board is used for work; or the two hub boards may work in a parallel manner, that is, each hub board performs exchange processing on the data; or the two hub boards may work in other user-defined manners.

In the slave exchange shelf, an I/O transfer board and a node board are disposed. As the I/O transfer board is disposed with no exchange unit or CPU, the I/O transfer board does not have the function of data exchange. The I/O transfer board only provides the function of data transfer, that is, the I/O transfer board provides the function of transferring the data of the node board in the shelf to the hub board in the master exchange shelf, so as to complete data exchange through the hub board in the master exchange shelf. Because the exchange unit and the CPU are not disposed, the manufacturing cost is reduced when compared with the hub board.

The hub board in the master exchange shelf is connected to the I/O transfer board in the slave exchange shelf by adopting an external communication link, such as, a cable or an optical fiber, or by adopting other external communication links.

In the following, the solution is further described by taking the application scenario of one-cabinet-and-multiple-shelves as an example.

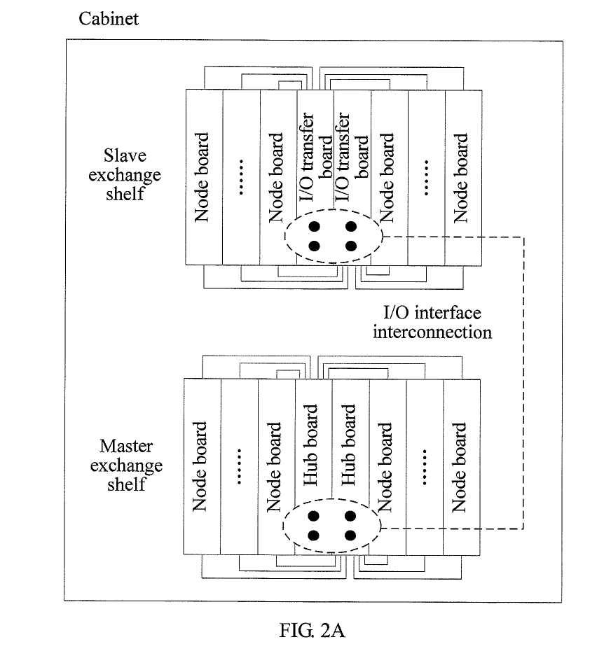

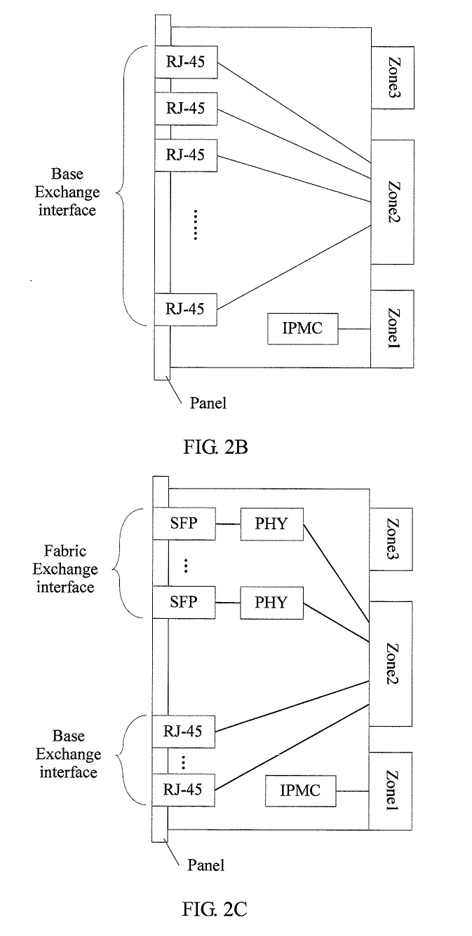

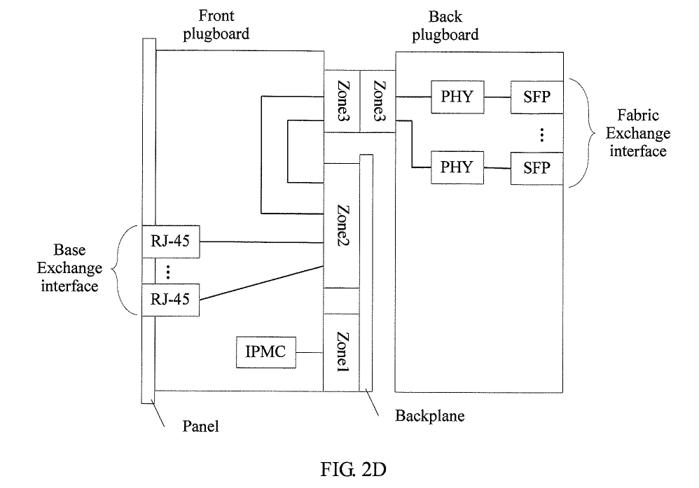

Referring to FIG. 2A, a schematic diagram of an exchange architecture according to an embodiment of the present invention is adopted in the application scenario of the one-cabinet-and-two-shelves ATCA. It can be seen from FIG. 2A that, in an ATCA cabinet, two shelves are included, where a master exchange shelf is located below in the drawing, and a slave exchange shelf is located above in the drawing.

In the embodiment of the present invention, the master exchange shelf is disposed with two hub boards, and the two hub boards are connected to a node board in the master exchange shelf through a dual-star exchange structure, that is, each hub board is connected to other node boards in the shelf through a backplane. Meanwhile, the two hub boards work in the redundancy backup manner, that is, usually one hub board is used as an active hub board, and when the active hub board fails, the other hub board is used as a spare hub board for work.

In the embodiment of the present invention, the slave exchange shelf is disposed with two I/O transfer boards, and the two I/O transfer boards are also connected to the node board in the slave exchange shelf through a dual-star structure, that is, each I/O transfer board is connected to other node boards in the shelf through a backplane. Meanwhile, the two I/O transfer boards also work in a redundancy backup manner, that is, usually one hub board is used as an active I/O transfer board, and when the active I/O transfer board fails, the other board is used as a spare I/O transfer board for work.

The hub board in the master exchange shelf is interconnected to the I/O transfer board in the slave exchange shelf through an I/O interface. Herein the I/O interface may be connected by adopting an external communication link such as a cable and an optical fiber. The external communication link is connected through a connection port that is provided on a panel of the hub board and a panel of the I/O transfer board, but not through a backplane.

In the embodiment of the present invention, the I/O transfer board in the slave exchange shelf may be implemented in multiple manners. FIG. 2B is a schematic diagram of the I/O transfer board adopting a base exchange interface. In an ATCA system, there are preset connection zones for the connections between the front plugboard, the backplane and the back plugboard, such as Zone 1, Zone 2 and Zone 3 as shown in FIG. 2B. Zone 1 is a power supply and management interconnection zone, and is used for connecting a power supply and a management controller. The management controller is mainly configured to manage events such as a board power supply, hot swap, and a high-temperature alarm, and referring to FIG. 2B, the embodiment of the present invention adopts an Intelligent Platform Management Controller (IPMC) for management. Zone 2 is an interconnection zone for a connection between a node board and another node, or for a connection between a node board and a hub board, or for a connection between a node board and an I/O transfer board, or for a connection between a node board and other types of front plugboards, and in the embodiment of the present invention, the connection of the node board with the hub board, and the connection of the node board with the I/O transfer board are implemented through Zone 2. Zone 3 is an interconnection zone of a front plugboard and a back plugboard, and a connection manner may be a user-defined manner.

In the ATCA system, Zone 2 supports a 10/100/1000 Base-T interface, so an RJ-45 connector may be directly configured on the panel of the I/O transfer board. As shown in FIG. 2B, multiple RJ-45 connectors are configured on the I/O board. According to the number of node boards, the number of the RJ-45 connectors may change, and in the embodiment of the present invention, fifteen or more RJ-45 connectors may be disposed, so as to ensure that each node boards in the slave exchange shelf has an individually corresponding I/O interface on the I/O transfer board, and ensure that each node board in the shelf can have an independent data communication channel with the hub board in the master exchange shelf. Inside of the panel, the RJ-45 connectors on the panel are connected to Zone 2, and outside the panel, the RJ-45 connectors are connected to the hub board in the master exchange shelf through the external communication link.

FIG. 2C is a schematic diagram of an I/O transfer board adopting base and fabric exchange interfaces according to another embodiment of the present invention. In the specification definition of the ATCA system, Zone 2 may provide the base and fabric exchange interfaces simultaneously, so in the embodiment of the present invention, two types of connectors, namely, a Small Form-Factor Pluggable (SFP) connector and an RJ-45 connector are adopted for respectively providing an exchange interface of a fabric plane and an exchange interface of a base plane. The fabric plane is a data plane, and is used for data exchange, and the base plane is a control plane, and is used for controlling or processing some data. As Zone 2 provides a 10/100/1000 Base-T interface, in order to support the SFP interface, a physical layer chip PHY needs to be disposed in the I/O transfer board, and is configured to implement a physical layer protocol. Meanwhile, according to different exchange protocols (such as 1000BASE-BX, 10 GBASE-KX4 and 10 GBASE-KR), different physical layer chip PHYs may be selected. The fabric exchange interface and the base exchange interface are also located on the panel of the I/O transfer board, where the fabric exchange interface is connected to an interface corresponding to the hub board in the master exchange shelf through an optical fiber, and the base exchange interface is connected to an interface corresponding to the hub board in the master exchange shelf through a cable.

FIG. 2D is a schematic diagram of providing a fabric exchange interface through a back plugboard according to another embodiment of the present invention. In the ATCA system, each front plugboard has a corresponding back plugboard, and the back plugboard is used to provide the user-defined functions; therefore, the back plugboard may be used to provide an exchange interface. Referring to FIG. 2D, in the embodiment of the present invention, an SFP interface and a PHY of a fabric plane are disposed on the back plugboard, and are connected to the front plugboard (herein, an I/O transfer board) through Zone 3. Meanwhile, an exchange interface corresponding to a hub board in a master exchange shelf is also disposed on the back plugboard, and an exchange interface of an I/O transfer board is connected to the back plugboard of the hub board in the master exchange shelf through an optical fiber. FIG. 2D shows an application scenario of disposing all the fabric exchange interfaces on the back plugboard. In actual application, only a part of the fabric exchange interfaces of the I/O transfer board may be disposed on the back plugboard and be connected to a connection port of the back plugboard of the hub board; meanwhile, all or a part of base interfaces may also be disposed on the back plugboard, and at this time, the back plugboard of the hub board of the master exchange shelf should also be disposed with a corresponding base interface, and be connected through a cable.

The structures of the above several I/O transfer boards are not unique, and according to the specification definitions, other interfaces may also be used for design.

The I/O transfer board is disposed in a slave exchange shelf, and is used to transfer the data to the hub board of the master exchange shelf, so as to complete data exchange through the hub board of the master exchange shelf; therefore, a hub board is not required to be disposed in each shelf, so as to reduce the manufacturing cost.

### Embodiment 3

The embodiment of the present invention further provides an ATCA exchange method, applicable in an ATCA exchange system, where the ATCA exchange system includes:

a master exchange shelf, including a hub board;

a slave exchange shelf, including a second node board and an I/O transfer board.

The method includes:

receiving data of the second node board;

outputting the data to the hub board through the I/O transfer board; and

completing data exchange through the hub board.

An external communication link includes a cable and/or an optical fiber.

An exchange interface is an RJ-45 interface and/or an SFP interface.

The exchange interface is located at a panel of a front plugboard and/or a panel of a back plugboard of the I/O transfer board.

A panel of a front plugboard and/or a panel of a back plugboard of the hub board includes a second exchange interface corresponding to the exchange interface.

In the embodiment of the present invention, the I/O transfer board is disposed in the slave exchange shelf, and is used to transfer the data to the hub board of the master exchange shelf, so as to complete data exchange through the hub board of the master exchange shelf; therefore, a hub board is not required to be disposed in each shelf, so as to reduce the manufacturing cost.

### Embodiment 4

The embodiment of the present invention further provides a communication apparatus, where the apparatus includes the ATCA exchange system in the foregoing system embodiments, and the communication apparatus may be a base station (BS), a server, or a gateway.

In the embodiment of the present invention, the I/O transfer board is disposed in the slave exchange shelf, and is used to transfer the data to the hub board of the master exchange shelf, so as to complete data exchange through the hub board of the master exchange shelf; therefore, a hub board is not required to be disposed in each shelf, so as to reduce the manufacturing cost.

What is claimed is:

1. An Advanced Telecommunications Computing Architecture (ATCA) exchange system, comprising:
a master exchange shelf, comprising a first node board and a hub board;
a slave exchange shelf, comprising a second node board and an I/O transfer board, wherein
the I/O transfer board comprises an exchange interface, and in the slave exchange shelf, the I/O transfer board is connected to the second node board through the exchange interface; and
the I/O transfer board is connected to the hub board by using an external communication link through the exchange interface, so that data of the second node board reaches the hub board through the I/O transfer board when the data needs to be exchanged, so as to complete data exchange through the hub board.

2. The exchange system according to claim 1, wherein
the external communication link comprises a cable and/or an optical fiber.

3. The exchange system according to claim 1, wherein
the exchange interface is an RJ-45 interface and/or a Small Form-Factor Pluggable (SFP) interface.

4. The exchange system according to claim 1, wherein
the exchange interface is located at a panel of a front plugboard of the I/O transfer board and/or a panel of a back plugboard of the I/O transfer board.

5. The exchange system according to claim 1, wherein
a panel of a front plugboard of the hub board and/or a panel of a back plugboard of the hub board comprises a second exchange interface corresponding to the exchange interface.

6. An Advanced Telecommunications Computing Architecture (ATCA) exchange method, applicable in an ATCA exchange system, wherein the ATCA exchange system comprises:
a master exchange shelf, comprising a hub board;
a slave exchange shelf, comprising a second node board and an I/O transfer board;
and the method comprises:
receiving data of the second node board;
outputting the data to the hub board through the I/O transfer board; and
completing data exchange through the hub board;

7. The ATCA exchange method according to claim 6, wherein
an external communication link comprises a cable and/or an optical fiber; and
an exchange interface is an RJ-45 interface and/or a Small Form-Factor Pluggable (SFP) interface.

8. The ATCA exchange method according to claim 6, wherein
an exchange interface is located at a panel of a front plugboard of the I/O transfer board and/or a panel of a back plugboard of the I/O transfer board; and
a panel of a front plugboard of the hub board and/or a panel of a back plugboard of the hub board comprises a second exchange interface corresponding to the exchange interface.

9. A communication apparatus, comprising the Advanced Telecommunications Computing Architecture (ATCA) exchange system according to claim 1.

10. The communication apparatus according to claim 9, wherein the communication apparatus may be a base station (BS), a server, or a gateway.
